(19) United States
(12) Patent Application Publication
(10) Pub. No.: US 2007/0182568 A1
(43) Pub. Date: Aug. 9, 2007

(54) ELECTRONIC TAG DEVICE

(76) Inventor: Kazuto Kokuryo, Shiga (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/672,260

(22) Filed: Feb. 7, 2007

(30) Foreign Application Priority Data
Feb. 7, 2006 (JP) P2006-030304

(51) Int. Cl. G08B 13/14

(52) U.S. Cl. 340/572.8

(57) ABSTRACT

To provide an electronic tag device capable of easily identifying glass sheets without damaging the glass sheets, an IC tag device 10 includes an IC tag 20 which is attachable or detachable to/from glass sheets. The IC tag 20 is attached on a surface of a base 40. An adhesive sheet 60 on which a plurality of adhesive pads 50 are formed is attached on a surface of the base 40 opposite to the surface where the IC tag 20 is attached. The base 40 may be attached or detached to/from the glass sheet by using the plurality of adhesive pads 50.

### BACKGROUND OF THE INVENTION

1. Field of the Invention

The present invention relates to an electronic tag device used to mount an electronic tag on an article. More specifically, the invention relates to an electronic tag device which is appropriate to mount the electronic tag on a glass sheet.

2. Description of the Related Art

Glass sheets for a vehicle have a plurality of shapes according to the kind of the vehicle. Even in a case of the same kind vehicle, the species of glass sheets (water-repellent glass, gradation processed glass, or glass having sound isolation function) may be different. Further, various kinds of vehicles have been created in accordance with a request of a market or a business strategy. Further, in order to induce more users, the kind of vehicles has been largely varied.

A plurality of kinds of vehicles or vehicles of different makers are produced in the same line for effective mass-production. Therefore, a company which supplies parts of the vehicle should sort the parts according to the order beforehand and then ship the sorted parts with respect to a production plan. In order not to remain the stocks in the line, the production plan should be performed in a short time from when the shipment is ordered according to the production plan until the parts are carried to the line.

For example, currently, one vehicle can be produced in a minute in a fast case. In this case, if the car to be shipped has five doors, the shipment should be prepared after checking the shapes and kinds of five glass sheets.

On the stock management or production management (assembly processing), since the glass sheet is transparent, it is difficult to classify the glass sheets with human eyes. Further, it is more difficult to determine the glass sheet which is colorless and has a plurality of functions, for example, the water-repellent glass sheet or the glass sheet having the sound isolation function.

The assembly processing means a processing of disposing a braid in the vicinity of glass sheets, shellacking, or fixing a mirror base. The assembly processing should be performed in accordance with a model number. Here, a plurality of glass sheets with different model numbers may have the same shape. In a case, when a mistake is made in application of black shellac or when a mirror base is fixed in inappropriate place, a value of the glass sheet as an article becomes low and the glass sheet becomes inferior goods.

As describe above, in the case of the glass sheet for a vehicle, there are a plurality of problems to be solved in the management or mass-production processing. It is the same in a glass sheet for the construction, in which the kind of glass sheet has been varied, such as, a security glass sheet, a water-repellent glass sheet, a glass sheet having the noise-isolation function, a glass sheet having a plurality thickness, and a colored glass sheet, for example, a green glass sheet.

In order to perform effective management and operation (mass-production processing, shipment processing, or stock managing processing) and to reduce mistakes, such as a picking mistake, a plurality of management systems have been proposed in each processing. The management system needs a unit for identifying a glass sheet. According to the related art, in order to identify the glass sheet, an edge portion of the glass sheet is colored (only when a customer agrees), a check sheet is used to manage the glass sheet, or a bar-code is used to manage the glass sheet. It is desired to construct a system for managing a glass sheet using an IC tag which attracts attention in recent years.

Patent Document 1: JP-A-2004-43212

In a glass identification unit used in a management system according to the related art, a decision by a human is generally used other than a case that a bar-code is used. Therefore, there is a problem to prevent a mistake. Meanwhile, in a management method using a bar-code or an information apparatus, since the decision by the human is seldom performed, some effects to solve the problem may be expected. However, there are a lot of problems for the operation in that the bar-code should be attached on the glass sheet, it is difficult to read the bar-code when the glass sheets are superimposed, and it is necessary to pay attention to stains.

Further, when managing a glass sheet using the IC tag, the glass sheet may be damaged when attaching the IC tag on the glass sheet. When attaching the IC tag on the glass sheet using a sealant member such as a-tape, there may remain treatment marks. Therefore, the appearance of the glass sheet may be injured.

Further, when the IC tag is mounted on the glass sheet and an electric wave is transmitted or received between the IC tag and a reader/writer through the glass sheet, there is a problem in that the electric wave may be attenuated due to the glass sheet.

### SUMMARY OF THE INVENTION

The invention has been finalized in consideration of the drawbacks inherent in the related art, and it is an object of the invention to provide an electronic tag device to easily identify glass sheets without injuring the glass sheet. Further, it is another object of the invention to provide an electronic tag device capable of preventing attenuation of an electric wave transmitted or received to/from the electronic tag due to the glass sheet.

According to an aspect of the invention, there is provided an electronic tag device that can attach/detach an electronic tag on/from a surface of an object. The electronic tag device includes: an electronic tag; a base on which the electronic tag is mounted; and a plurality of adhesive pads provided on a surface of the base.

According to the aspect of the invention, it is possible to place the base on which the electronic tag is mounted to be attached or detached on/from a surface of the glass sheet. Therefore, it is possible to easily identify an object by using the electronic tag. Further, since the base on which the electronic tag is mounted may be easily attached or detached on/from the glass sheet by using the plurality of adhesive pads, it is possible to reduce mistakes due to an operator and restrict to damage the glass sheet. Further, since it is not necessary to use a sealant in order to mount the electronic tag on the glass sheet, it is possible to keep the appearance of the glass sheet without remaining treatment marks.

According to the aspect of the invention, the electronic tag may be provided at a position separated from the surface where the plurality of adhesive pads are provided in a normal direction of the surface.

According to the aspect of the invention, since the electronic tag is mounted on the glass sheet while the glass sheet is separated from the electronic tag, the electric wave transmitted or received from/to the electronic tag seldom receives the effect from the glass sheet.

According to the aspect of the invention, the plurality of adhesive pads may be formed on a sheet capable of being attached or detached to/from the base.

According to the aspect of the invention, even when the adhesive force of the adhesive pad becomes low, it is possible to rapidly refresh the adhesive force by changing the sheet. Further, when the adhesive force of the adhesive pad becomes low, it is possible to clean only the sheet on which the plurality of adhesive pads is formed without affecting the electronic tag by separating the sheet.

According to another aspect of the invention, there is provided an electronic tag device including: an electronic tag; a base on which the electronic tag is mounted; and an adhesive sheet that is connected to the base while being protruded from the base and has at least a surface on which a plurality of adhesive pads provided.

According to the aspect of the invention, it is possible to place the base on which the electronic tag is mounted to be attached or detached on/from a surface of the glass sheet. Therefore, it is possible to easily identify an object by using the electronic tag. Further, since the base on which the electronic tag is mounted may be easily attached or detached on/from the glass sheet by using the plurality of adhesive pads, it is possible to reduce mistakes due to an operator and restrict to damage the glass sheet. Further, since it is not necessary to use a sealant in order to mount the electronic tag on the glass sheet, it is possible to keep the appearance of the glass sheet without remaining treatment marks. Further, since it is possible to extend the base on which the IC tag is mounted in a plane direction of the glass sheet from the end portion of the glass sheet by attaching the adhesive sheet of the base to an end portion of the glass sheet, the electric wave transmitted or received from/to the electronic tag seldom receives the effect from the glass sheet. Further, when a plurality of adjacent glass sheets are arranged to be mounted on a valet, it is possible to insert the adhesive sheet into a space between the adjacent glass sheets and attach the adhesive sheet to each glass sheet.

According to the aspect of the invention, a strap capable of being used when the plurality of adhesive pads are separated from an object is attached to the base or the adhesive sheet.

According to the aspect of the invention, it is possible to easily separate the electronic tag device by using the strap even in a case that it is difficult to separating the adhesive sheet, for example, when the adhesive sheet is inserted into a space between the adjacent glass sheets and is attached to the glass sheet.

The above-described electronic tag device is preferably used to identify the glass sheets by using the electronic tag.

Further, combinations of the above-described elements may be included in the scope of the invention.

According to the aspect of the invention, it is possible to easily identify glass sheets using the electronic tag without injuring the glass sheet. Further, according to the aspect of the invention, when the electronic tag is attached to the glass sheet, it is possible to make the electric wave transmitted or received to/from the electronic tag be free from the glass sheet.

### BRIEF DESCRIPTION OF THE DRAWINGS

FIG. 1 is a perspective view of an IC tag device according to a first embodiment of the invention.

FIG. 2 is a side view of the IC tag device according to the first embodiment of the invention.

FIG. 3 is a view illustrating an external appearance of the IC tag mounted on the IC tag device.

FIG. 4 is a block diagram illustrating a functional structure of the semiconductor chip included in the IC tag.

FIG. 5 is a side view illustrating an IC tag device according to a second embodiment.

FIG. 6 is a perspective view illustrating an IC tag device according to a third embodiment of the invention.

FIG. 7 is a side view illustrating the IC tag device according to the third embodiment of the invention.

FIG. 8 is a view illustrating a state where the IC tag device is attached on a glass sheet according to the third embodiment of the invention.

FIG. 9 is a schematic view illustrating a subsidiary device used to attach/detach the IC tag device to/from a glass sheet according to the third embodiment of the invention.

FIG. 10 is a view illustrating a more preferable embodiment than the IC tag device according to the third embodiment.

### DESCRIPTION OF THE PREFERRED EMBODIMENTS

Embodiments according to the invention will be described with reference to accompanying drawings.

### First Embodiment

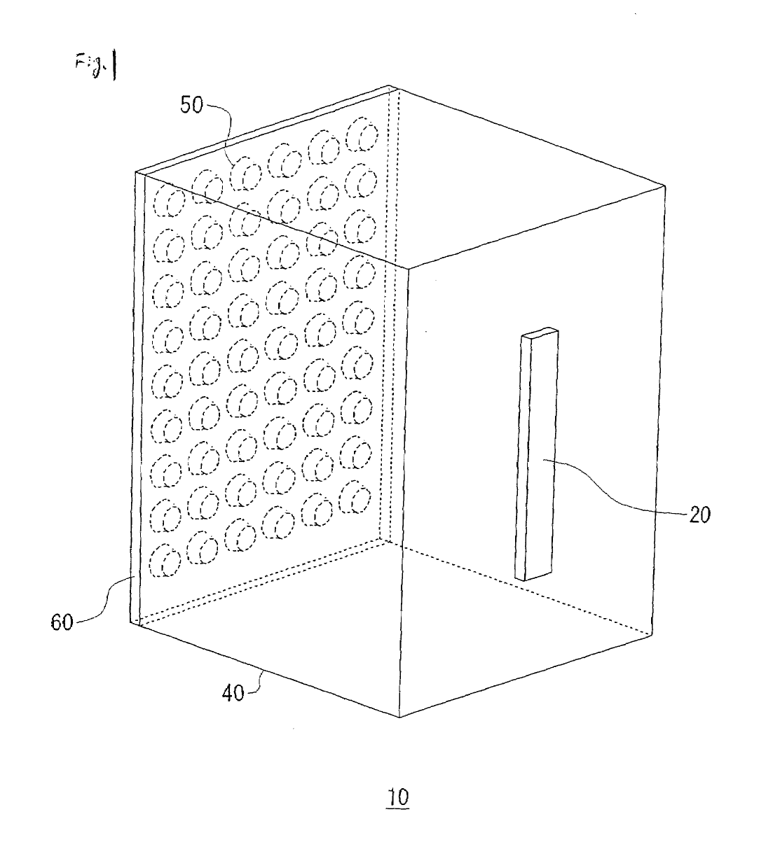

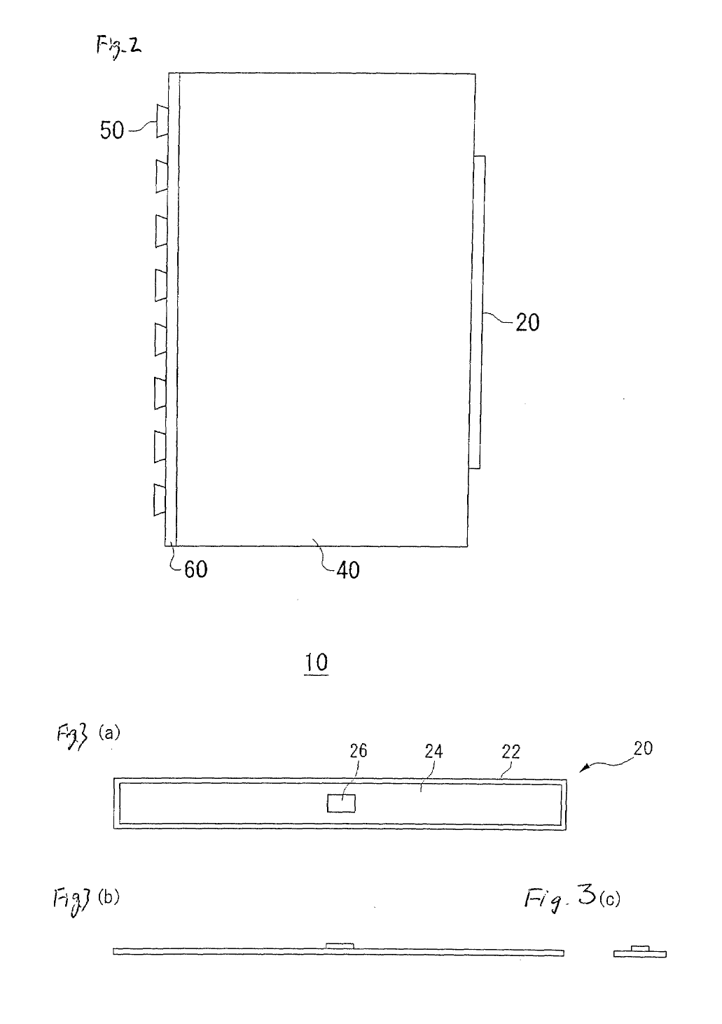

FIG. 1 is a perspective view of an IC tag device 10 according to a first embodiment of the invention and FIG. 2 is a side view of the IC tag device 10 according to the first embodiment of the invention. According to the first embodiment of the invention, the IC tag device 10 has an IC tag which is attachable and detachable on/from a surface of a glass sheet. The IC tag device 10 includes an IC tag 20, a base 40, and a plurality of adhesive pads 50.

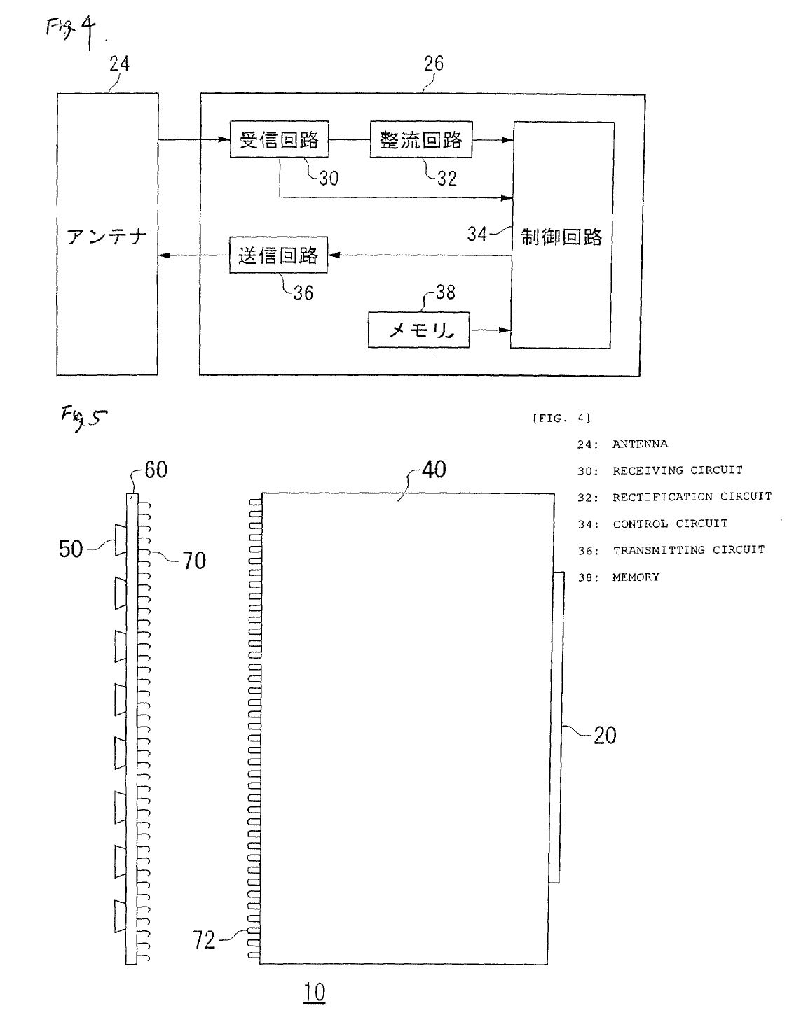

FIGS. 3A to 3C are views illustrating an appearance of the IC tag 20. FIG. 3A is a plan view illustrating the appearance of the IC tag 20. FIG. 3B is a front view illustrating the appearance of the IC tag 20. FIG. 3C is a side view illustrating the appearance of the IC tag 20. The IC tag 20 includes a rectangular shape insulating film 22, an antenna 24 which is formed on both sides of the insulating film 22 so as to receive and transmit an electric wave such as a microwave, and two semiconductor chips 26 which are wireless chips connected to the antenna 24 and transmitting predetermined data in response to a request from the external by a wireless communication through the antenna 24. Further, the antenna 24 and the semiconductor chips 26 may be formed on only one side of the insulating film 22.

The IC tag 20 may store data in a memory circuit in the semiconductor chip 26 and read the data using the electric wave such as the microwave or an UHF wave without contact. Therefore, the IC tag 20 may generally store a large amount of data as compared with a bar-code or a two-dimensional bar-code. Further, since the IC tag 20 is not a printing matter such as the bar-code or the two-dimensional bar-code, it is difficult to fabricate the data.

The antenna 24 is formed by applying conductive material, for example, a conductive paste whose main component is copper or silver on the insulating resin film 22. The antenna 24 is designed to effectively transmit and receive an electric wave at a predetermined frequency, for example, a microwave of 2.45 GHz. The antenna 24 may exemplarily have a loop shape but the invention is not limited thereto.

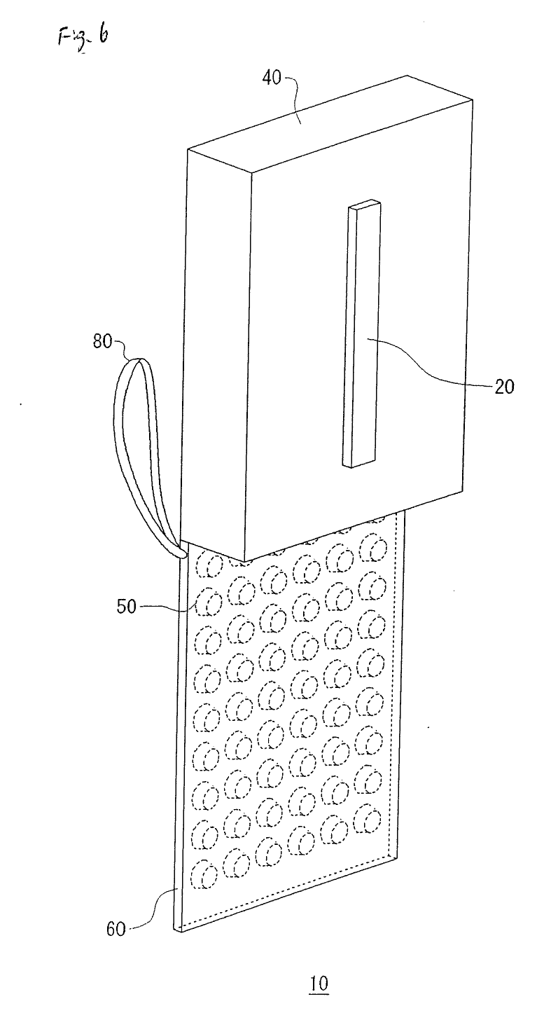

The semiconductor chip 26 is manufactured by forming a circuit shown in a functional block diagram of FIG. 4 which will be described later on a single crystal silicon base. Since the thin antenna 24 is formed on one side of the insulating film 22, the IC tag 20 is thin and fluent. The semiconductor chip 26 is a so-called passive semiconductor chip which is driven by an electromotive force due to the electric wave received from the external. Since the above-described passive wireless chip does not have a power supply, it can be manufactured to be smaller than an active semiconductor which has a power supply formed therein. The antenna 24 and the semiconductor chip 26 may be sealed by the resin and so on.

FIG. 4 is a block diagram illustrating a functional structure of the semiconductor chip 26. The semiconductor chip 26 includes a receiving circuit 30, a rectification circuit 32, a control circuit 34, a transmitting circuit 36, and a non-volatile memory 38. The receiving circuit 30 outputs the electric wave received by the antenna 24 to the rectification circuit 32, generates a clock signal on the basis of the electric wave received by the antenna 24, and outputs the generated clock signal to the control circuit 34. The rectification circuit 32 rectifies the electric wave transmitted from the receiving circuit 30 and converts the rectified electric wave into an electric power which becomes a driving source of the control circuit 34 so as to output the electric power to the control circuit 34.

When the clock signal is input to the control circuit 34 from the receiving circuit 30, the control circuit 34 reads out predetermined data from the memory 38 and outputs an information signal according to the read data with a transmitting signal to the transmitting circuit 36. The transmitting circuit 36 modulates the transmitting signal input from the control circuit 34 into the information signal and transmits the modulated signal to the external through the antenna 24. The transmitted signal is received by a reading device (not shown) provided at the external.

At least, a unique identification number is written in the memory 38 and the memory 38 may store a plurality of data. If the identification number is transmitted in wireless, the identification number may be used to manage glass sheets on which the IC tags 20 are mounted. The data to be stored in the memory 38 may be manufacture related attribute, such as, a manufacture number of glass sheet, a production period, a producing center, a producing process, or a distribution history, and product related attribute, such as, the ingredient or a function of the glass sheet. However, the invention is not limited thereto.

The semiconductor chip 26 may be used with electric waves having a plurality of frequencies which are generally used, for example, 135 kHz, 13.56 MHz, 433 MHz, 869 MHz, 915 MHz, or 2.45 GHz. Each of the above-described electric waves has an individual characteristic. Therefore, it is preferable to use the IC tag 20 in accordance with the characteristics of the electric waves having the predetermined frequencies. For example, in the electric wave of 869 MHz, it is possible to perform a long distance communication. Therefore, even though the IC tag 20 is separated from the reading device, it is easy to use the IC tag 20. Further, in a case of the IC tag 20 which uses the electric wave at 2.45 GHz, it is easy to make the IC tag 20 be small.

According to the first embodiment of the invention, the semiconductor chip 26 is used only for reading data. However, it is possible to use a semiconductor chip, such as an EEPROM, capable of reading or writing data. In a case of the semiconductor chip capable of reading or writing data, it becomes easy to mange the distribution history by additionally writing data in a memory at each distribution step of the glass sheet.

The IC tag 20 may have the above-described structure but the invention is not limited thereto. Therefore, it is possible to use a general-purpose article of 2.45 GHz, which is come into the market, as the IC tag 20. Since a general-purpose article may be used as the IC tag 20, it is possible to reduce the manufacturing cost of the IC tag device 10.

The IC tag 20 is mounted in the base 40 by attaching the IC tag 20 on the surface of the base 40. According to the first embodiment of the invention, the IC tag 20 is exposed but the IC tag 20 may be buried in the base 40.

It is preferable to use a light-weight and nonmetal material, such as, Styrofoam, as the base 40. It is possible to reduce the weight of the entire IC tag device 10 and to easily treat the IC tag device 10 by reducing the weight of the base 40. In addition, even in a case of crashing the IC tag device 10 against the glass sheet, the impact given to the glass sheet is small. Therefore, the glass sheet is not damaged. Since the base 40 is formed of the nonmetallic material, it is possible to reduce the effect of the base on the electric wave to be transmitted or received from/to the IC tag 20.

An adhesive sheet 60 on which a plurality of adhesive pads 50 are arranged is attached on a surface of the base 40, which is opposite to the surface on which the IC tag 20 is attached. For example, the adhesive sheet 60 may be manufactured by screen printing an ink for the adhesive pad which is soft and combustible on a sheet formed of a flexible polyvinyl chloride, polyester, or polyolefin.

The plurality of adhesive pads 50 may have characteristics as follows.

(1) The plurality of adhesive pads may be attached on a surface of a glass sheet by compression.

(2) It is easy to separating the plurality of adhesive pads.

(3) The plurality of adhesive pads may be repeatedly used.

(4) It is easy to clean stain from the plurality of adhesive pads.

According to the above-described IC tag device 10, it is possible to easily place the IC tag 20 which stores an ID for identifying each glass sheet on the glass sheet. Further, since a mistake by a human can be reduced when mounting the IC tag on the glass sheet, damages to the glass sheet may be restrained. Since sealants are not necessary to mount the electronic tag on the glass sheet, it is possible to keep the appearance of the glass sheet without remaining treatment marks. Further, since a general-purpose article may be used as the IC tag to be mounted on the electronic tag device, it is possible to reduce the production cost for the electronic tag device.

It is assumed that the IC tag 20 is in the vicinity of the glass sheet. When the electric wave transmitted or received to/from the IC tag 20 passes through the glass sheet, the intensity of the electric wave may be attenuated. Therefore, it is preferable that the IC tag 20 is provided at a position separated from the surface where the plurality of adhesive pads 50 are provided in a normal direction of the surface. Accordingly, since the IC tag 20 is mounted on the glass sheet while the IC tag 20 is separated from the glass sheet, the electric wave transmitted or received to/from the IC tag 20 is seldom affected by the glass sheet. The intensity of the electric wave is remarkably attenuated due to the glass sheet when the distance between the surface of the glass sheet and the IC tag 20 is less than 3 cm. Therefore, it is preferable that the IC tag 20 is provided at a position separated by a distance equal to or more than 3 cm from the surface where the plurality of adhesive pads 50 are provided in the normal direction of the surface.

In this embodiment, the adhesive sheet 60 in which the plurality of adhesive pads 50 are formed is attached on the base 40 but the plurality of adhesive pads 50 may be directly formed on the base 40.

### Second Embodiment

FIG. 5 is a side view illustrating an IC tag device 10 according to a second embodiment. The basic structure of the IC tag device 10 according to the second embodiment of the invention is the same as the first embodiment. The same reference numerals are used to indicate the same structure as the first embodiment and the description thereof will be omitted.

The IC tag device 10 according to the second embodiment of the invention includes a plurality of hooks 70 provided on one surface of an adhesive sheet 60 which has another surface where a plurality of adhesive pads 50 are formed. Further, a plurality of loops 72 are arranged on the base 40 so as to attach or detach the plurality of hooks 70. That is, in the IC tag device 10 according to the second embodiment of the invention, the adhesive sheet 60 may be attached or detached on/from the base 40 by a surface fastener having the plurality of hooks 70 and the plurality of loops 72.

Therefore, when an adhesive force of the plurality of adhesive pads 50 becomes weak, the adhesive force may be rapidly refreshed by replacing the adhesive sheet 60. Further, when an adhesive force of the plurality of adhesive pads 50 becomes weak, it is possible to clean only the adhesive sheet 60 without affecting the IC tag 20 by detaching the adhesive sheet 60.

### Third Embodiment

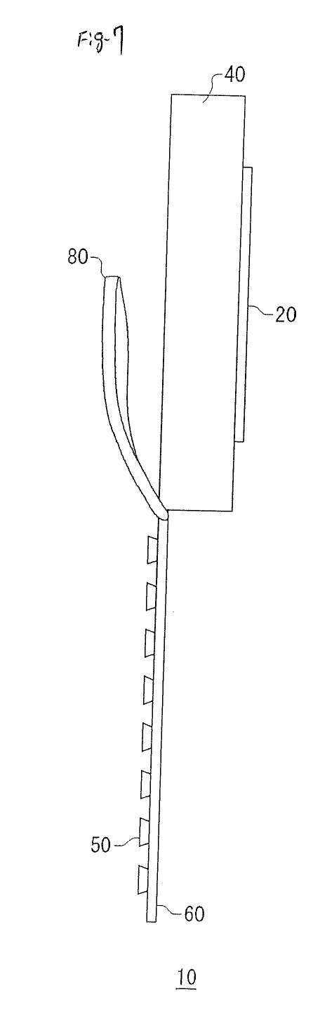

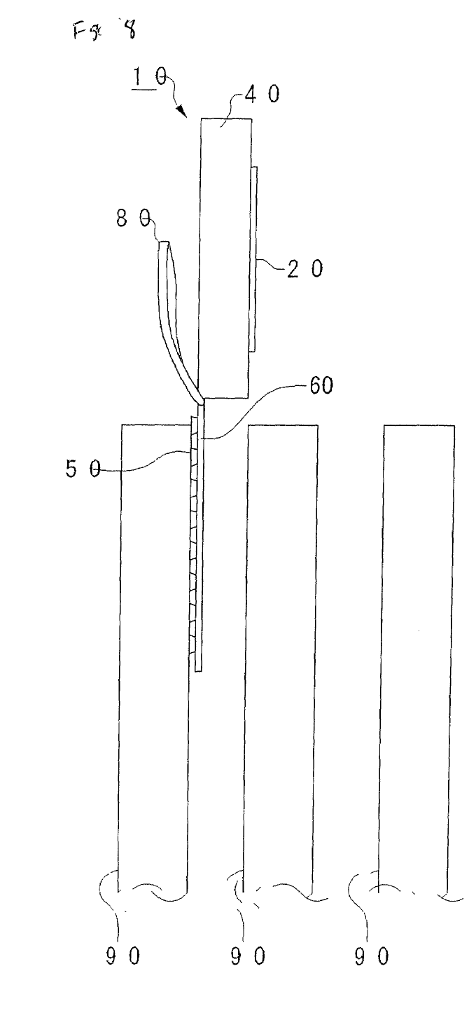

FIG. 6 is a perspective view illustrating an IC tag device 10 according to a third embodiment of the invention. FIG. 7 is a side view illustrating the IC tag device 10 according to a third embodiment of the invention. In the IC tag device 10 according to the third embodiment of the invention, the same reference numerals will be used to indicate the same structure of the first embodiment and the description thereof will be omitted.

The IC tag device 10 according to the third embodiment of the invention includes an IC tag 20, a base 40 on which the IC tag is mounted, and an adhesive sheet 60 which is connected to the base 40 while being protruded from the base 40 and has a plurality of adhesive pads 50 on one surface.

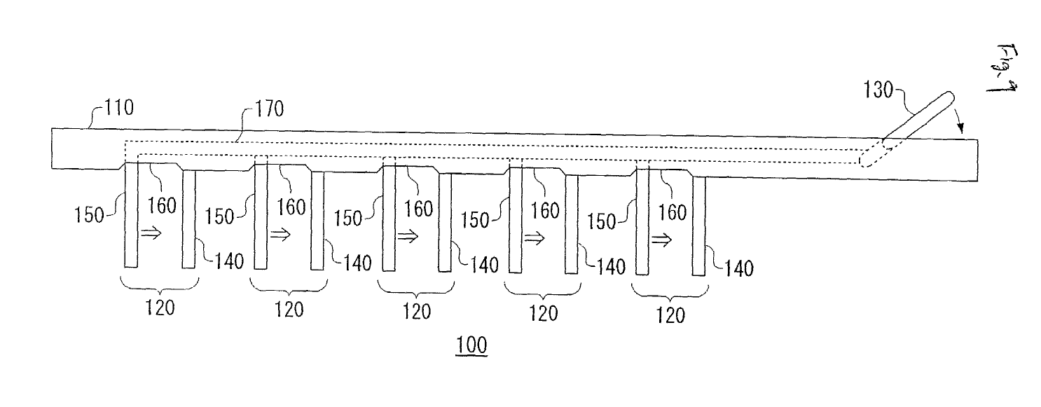

According to the third embodiment of the invention, as shown in FIG. 8, even when a plurality of glass sheets 90 are arranged to be mounted on a valet and there are not enough space between the adjacent glass sheets 90, it is possible to insert the adhesive sheet 60 on which the plurality of adhesive pads 50 are formed into a space between the adjacent glass sheets 90 so as to attach the plurality of adhesive pads 50 on one end portion of the glass sheet 90. Therefore, it is possible to provide the base 40 including the IC tag 20 in a region where the glass sheet 90 does not affect. That is, it is possible to provide the base 40 in a region separated from the end portion of the glass sheet 90 while being extended in a plane direction of the glass sheet 90. Therefore, it is possible to prevent the attenuation of the electric wave transmitted or received to/from the IC tag due to the block of the glass sheet.

A strap 80 is attached to the adhesive sheet 60 that can be used to separate, from the glass sheet, the plurality of adhesive pads 50 attached thereon. Therefore, even in a case when it is difficult to detach adhesive sheet 60 from the glass sheet, such as a case when the adhesive sheet 60 is inserted into the space between the adjacent glass sheets so as to be adhered to the glass sheet, it is possible to easily detach the electronic tag device 10 from the glass sheet by using the strap 80. The strap 80 may be attached to the base 40.

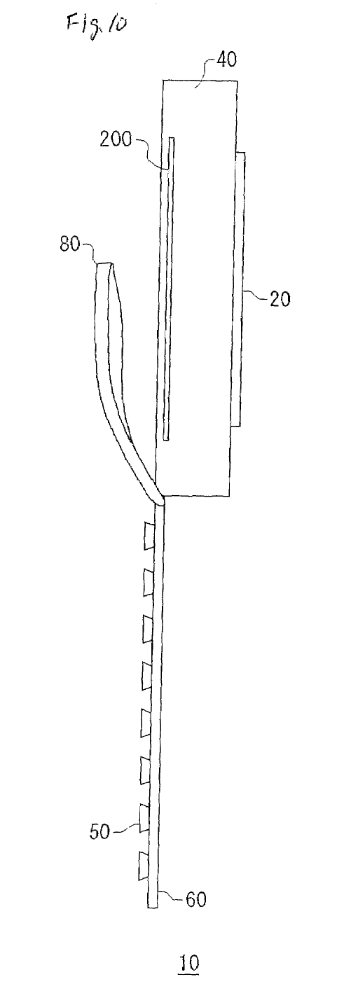

FIG. 9 is a schematic view illustrating a subsidiary device 100 used to attach/detach the IC tag device 10 to/from the glass sheet according to the third embodiment of the invention. The subsidiary device 100 includes a support bar 110, a plurality of clamping portions 120 connected to the support bar 110 and each capable of clamping the IC tag device 10, and a clamping control lever 130 capable of controlling the IC tag device clamping operation of the clamping portion 120.

The insertion portion 120 includes a fixed member 140 fixed to the support bar 110 and a moving member 150 used to clamp the IC tag device 10 while being a pair with the fixed member 140. Each of the moving members 150 is connected to a moving bar 170 mounted in the support bar 110 through a slit 160 provided in the support bar 110.

The moving bar 170 moves in the support bar 110 in accordance with the operation of the clamping control lever 130. The clamping control lever 130 and the support bar 110 are connected to each other by the following structure. When the clamping control lever 130 is fastened, the moving bar 170 moves toward the clamping control lever 130. Therefore, each of the moving members 150 is urged against each of the fixed members 140 in association with the moving bar 170. Therefore, it is possible to insert the IC tag device 10 according to the third embodiment of the invention between each of the fixed members 140 and each of the moving members 150. Meanwhile, when the insertion control lever 130 is loosened, the moving bar 170 moves into the direction opposite to the clamping control lever 130. Therefore, each moving member 150 is urged against each fixed member 140 present on a side opposite to the fixed member being a pair with the corresponding moving member 150 in association with the moving bar 170. Therefore, it is possible to cancel the insertion state of the IC tag device 10 according to the third embodiment of the invention.

Therefore, according to the third embodiment of the invention, it is possible to attach or detach the plurality of IC tag devices 10 to/from the plurality of glass sheets at once. Accordingly, it is possible to improve the efficiency of an operation of attaching or detaching the IC tag device 10 to/from the glass sheet.

In the IC tag device 10 according to the third embodiment of the invention, it is preferable to provide a metal foil 200 on a surface of the base 40, which is opposite to the surface where the IC tag 20 is attached (see FIG. 10). The electric wave transmitted or received from/to the IC tag 20 is reflected by the metal foil 200. Therefore, when a reader/writer is mounted on a side opposite to the metal foil 200, it is possible to increase the intensity of the electric wave transmitted or received between the IC tag 20 and the reader/writer, thereby extending an electric wave range. The interval between the metal foil 200 and the IC tag 20 may be set in accordance with the frequency of the electric wave transmitted or received from/to the IC tag 20.

The invention is not limited the above-described embodiments and those skilled in the art will appreciate that various modifications, additions and substitutions are possible, that is, modification in a design on the basis of the knowledge of those skilled. Further, the modifications may be included in the invention as disclosed in the accompanying claims.

For example, in the second embodiment of the invention, the loops 72 may be provided not only on the surface which is opposite to the IC tag 20 but also on side surfaces. Therefore, the adhesive sheet 60 may be formed to be larger than the surface which is opposite to the IC tag 20 and which the loops 72 are provided. Accordingly, it is possible to wind the adhesive sheet 60 around the base 40 by using the surface fastener. Further, if the adhesive sheet 60 is wound around along the side surfaces of the base 40, the base 40 may be mounted on the glass sheet while the IC tag 20 is facing the plane direction of the glass sheet.

Further, in the third embodiment of the invention, the adhesive sheet 60 may be attached or detached to/from the base 40 by using the surface fastener. Therefore, as the same as the second embodiment of the invention, when the adhesive force of the plurality of adhesive pads 50 becomes low, it is possible to rapidly refresh the adhesive force by changing the adhesive sheet 60. Further, if the adhesive sheet 60 is detached when the adhesive force of the plurality of adhesive pads 50 becomes low, it is possible to clean only the adhesive sheet 60 while the IC tag 20 is not affected.

1. An electronic tag device comprising:
an electronic tag;
a base on which the electronic tag is provided; and
a plurality of adhesive pads provided on a surface of the base.

2. The electronic tag device according to claim 1, wherein the electronic tag is provided at a position separated from the surface where the plurality of adhesive pads are provided in a normal direction of the surface.

3. The electronic tag device according to claim 1, wherein the plurality of adhesive pads are formed on a sheet capable of being attached or detached to/from the base.

4. An electronic tag device comprising:
an electronic tag;
a base on which the electronic tag is mounted; and
an adhesive sheet that is connected to the base while being protruded from the base and has at least a surface on which a plurality of adhesive pads provided.

5. The electronic tag device according to claim 4, wherein a strap capable of being used when the plurality of adhesive pads are separated from an object is attached to the base or the adhesive sheet.

6. The electronic tag device according to claim 1, wherein an object where the electronic tag device is mounted is a glass sheet.

7. The electronic tag device according to claim 4, wherein an object where the electronic tag device is mounted is a glass sheet.
